(19) United States
(12) Patent Application Publication
(10) Pub. No.: US 2012/0127738 A1
(43) Pub. Date: May 24, 2012

(54) LAMP HOUSING INCLUDING UTILITY DOOR FOR MOUNTING ELECTRONIC BALLAST

(75) Inventors: Shawn DeKalb, San Diego, CA (US); Benjamin D. Wampler, San Diego, CA (US); Paul Srimuang, San Diego, CA (US)

(73) Assignee: Empower Electronics, Inc.

(21) Appl. No.: 12/949,707

(22) Filed: Nov. 18, 2010

(51) Int. Cl. F21V 29/00

(52) U.S. Cl. 362/373

(57) ABSTRACT

A utility door for a lamp housing includes a utility door housing, an electronic ballast and a heat coupler. The utility door housing includes an inside surface, and closes a portion of an outside surface of the lamp housing. The electronic ballast is mounted to the inside surface. The electronic ballast delivers power to the lamp, and includes a heat dissipater. The heat coupler thermally couples the heat dissipater to an outside atmosphere surrounding the utility door housing.

### BACKGROUND

Illuminators utilizing high intensity discharge lamps are in wide use for the illumination of various venues such as roadsides, automotive parking lots, warehouses, arenas, stadiums, and other places requiring high illumination power with high efficiency. The need for greater efficiency has resulted in recent improvements to the ballasts such as the implementation of microprocessor-controlled ballasts to replace older magnetic ballasts. These new ballasts have advantages such as being able to adjust output as an arc lamp ages, providing a higher efficiency and greater predictability of output to the lamp over time.

The newer ballasts raise new challenges including how to properly mount the ballasts to avoid damage to microprocessor controlled electronic components and how to remove or dissipate heat generated by the electronics.

### SUMMARY

The present invention is directed toward a utility door for a lamp housing. In one embodiment, the utility door includes a utility door housing, an electronic ballast and a heat coupler. The utility door housing includes an inside surface, and closes a portion of an outside surface of the lamp housing. The electronic ballast is mounted to the inside surface. The electronic ballast delivers power to the lamp, and can include a heat dissipater. The heat coupler thermally couples the heat dissipater to an outside atmosphere surrounding the utility door housing.

In one embodiment, the utility door housing includes a mounting surface so that the electronic ballast can be attached thereto.

In certain embodiments, the heat dissipater includes one of a transformer and a heat sink for a processor. In some embodiments, the heat coupler includes one of a heat pipe, a metal conductor, a potting compound, and a forced air system.

In accordance with one embodiment, the heat coupler includes a metal strip.

In certain embodiments, the heat coupler can include a first end and a second end. In these embodiments, the first end can be thermally coupled to the heat dissipater, while the second end can be coupled to an inside surface of the utility door housing.

In accordance with one embodiment, the heat coupler can include two or more thermal conductors, with each thermal conductor being coupled to a separate heat dissipater of the electronic ballast.

In some embodiments, the inside surface of the utility door can include a lower portion and a lateral portion. In these embodiments, the lower portion can include a mounting portion for mounting the electronic ballast, and the heat coupler can be thermally coupled to the lateral portion.

The present invention can also include a method for manufacturing a utility door for a lamp housing that includes some or all of the features described herein.

### BRIEF DESCRIPTION OF THE DRAWINGS

FIG. 1 is a top perspective view of one embodiment of a lamp housing including a utility door having features of the present invention;

FIG. 2 is a bottom view of the lamp housing illustrated in FIG. 1;

FIG. 3 is a side view of the utility door illustrated in FIG. 1;

FIG. 4 is a bottom view of the utility door illustrated in FIG. 1;

FIG. 5 is a top perspective view of a portion of the utility door illustrated in FIG. 1 including a ballast;

FIG. 6 is a top perspective view of the utility door illustrated in FIG. 1 including one or more protective covers covering the ballast;

FIG. 7 is a top view of the portion of the utility door illustrated in FIG. 5;

FIG. 8 is a block diagram of one embodiment of an electronic ballast utilized in the present invention; and

FIG. 9 is a top perspective view of another embodiment of the utility door having features of the present invention.

### DESCRIPTION

In the following description directional descriptors such as “downward” and “lateral” are used and are intended to reference mutually orthogonal axes X, Y, and Z that are illustrated in the Figures. The term “downward” refers to the −Z direction and the term “lateral” refers to the X and Y-axes. However, “downward” may not be aligned in a gravitational sense, but may refer to a direction that is angled or inclined relative to the direction of gravity. Generally, all of these directional terms refer to the Figures and are not intended to be otherwise limited. Thus, as a non-exclusive example, a lamp housing 2 that is depicted in the present invention may be mounted such that its long axis (aligned with the X-axis) is inclined at a one to ten degree (or more) angle relative to a horizontal plane that is orthogonal to the direction of gravity.

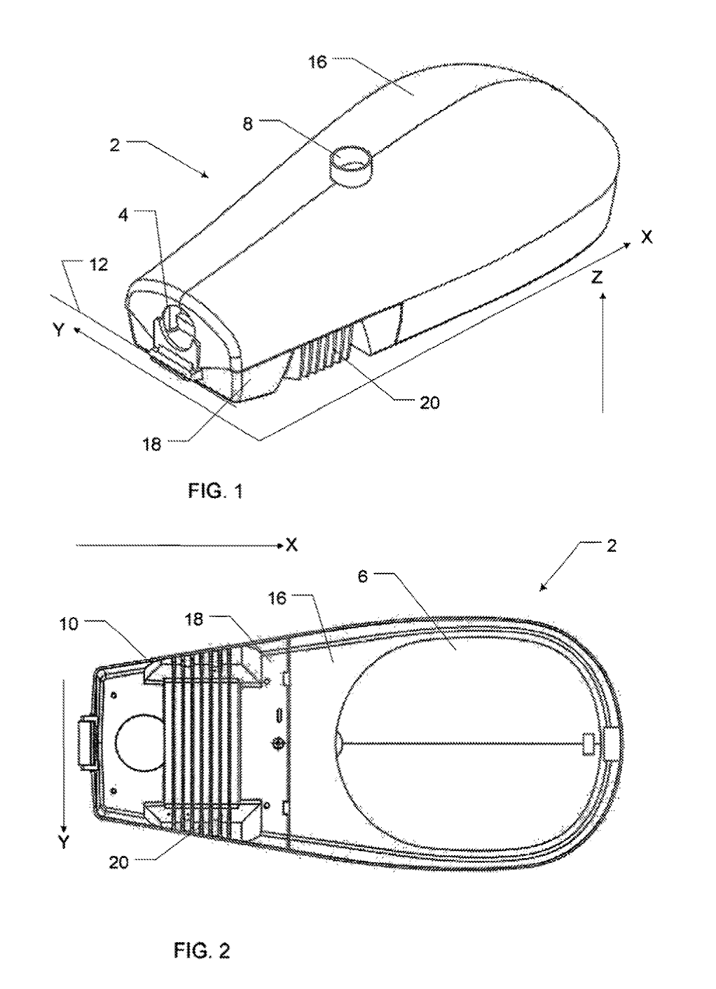

Top perspective and bottom views of a lamp housing 2 according to the present invention are depicted in FIGS. 1 and 2 respectively. Lamp housing 2 is configured to be mounted above an area to be illuminated using a nearly horizontal pole that attaches through opening 4. When lamp housing 2 is mounted, lamp 6 faces and emits light downwardly (along a Z axis or the −Z direction according to the figures). In one embodiment, above lamp 6 is a photo detector 8 that senses ambient light and provides a signal determining when lamp 6 is to be activated. Thus, sensor 8 enables lamp 6 to be turned on when ambient (sun) light intensity is below a certain threshold and to turn off when the ambient light intensity returns to that threshold.

Lamp housing 2 includes a utility door 10 that allows access to and closure to an interior of the lamp housing 2. Utility door 10 is located at an opposing end of housing 2 relative to lamp 6 along the lateral X-axis as illustrated in FIGS. 1 and 2. The utility door 10 is configured to be removed by pivoting the utility door 10 about a hinge axis 12 that is parallel to the Y-axis. Lamp housing 2 has an outer surface 16. Utility door 10 has an outer surface 18 that forms a portion of lamp outer surface 16 when utility door 10 is installed and in use as a part of lamp housing 2. In some embodiments, outer surface 18 includes one or more cooling fins 20 that can extend outwardly, laterally, and downwardly relative to utility door 10 and which provide convective cooling of utility door 10.

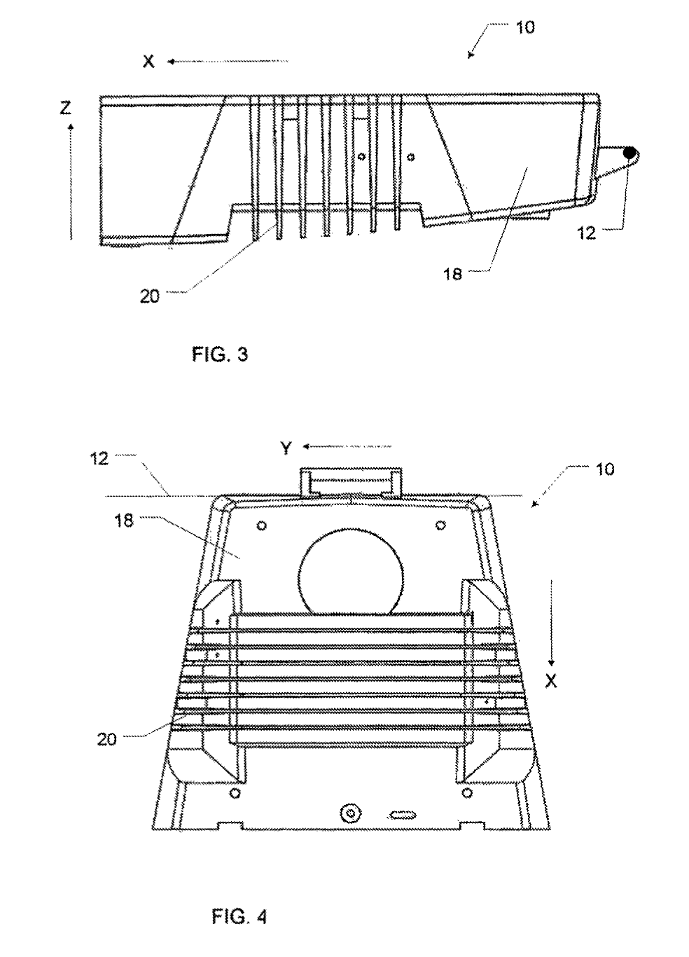

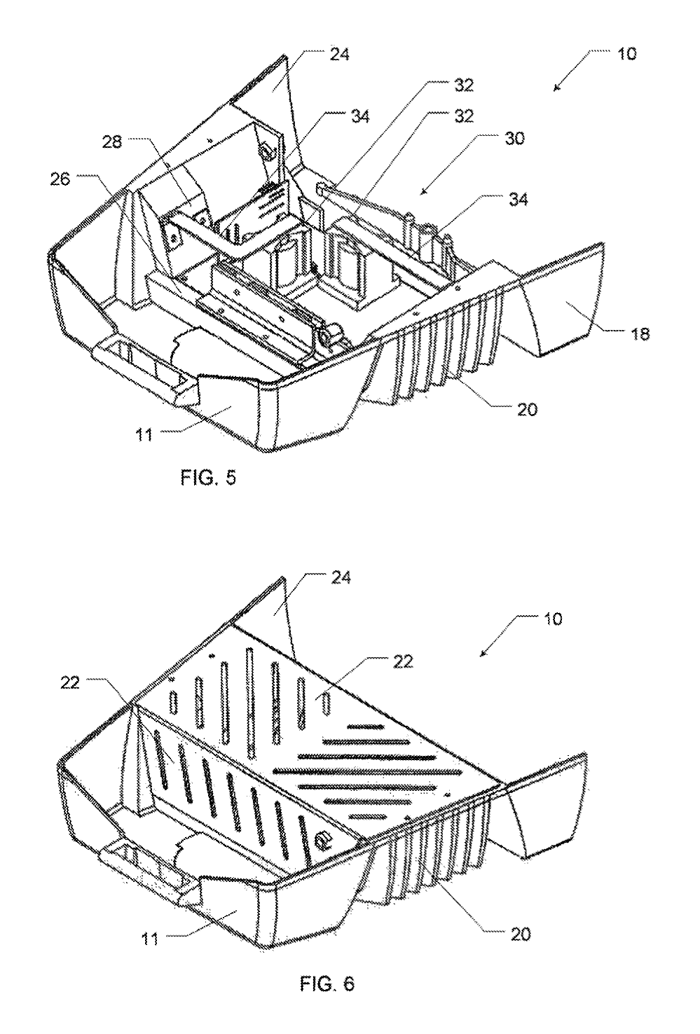

FIGS. 3 and 4 depict side and bottom views, respectively, of utility door 10 in isolation from the remainder of lamp housing 2. The hinge axis 12 allows the utility door 10 to pivot substantially about the Y-axis (illustrated in FIG. 1) in a generally downwardly direction relative to lamp housing 2. Also depicted are cooling fins 20 that extend laterally (in the plus and minus Y-direction) and downwardly (in the minus Z-direction) relative to outside surface 18 of utility door 10.

FIG. 5 is a top perspective view of a portion of the utility door 10 with protective covers 22 (illustrated in FIG. 6) removed while FIG. 6 is a top perspective view of the utility door 10 with protective covers 22 in place. Utility door 10 includes a utility door housing 11 having an inside surface 24 that opposes outside surface 18. Inside surface 24 includes a mounting surface 26 and a lateral inside surface 28. A ballast 30 is attached to mounting surface 26 of inside surface 24. Ballast 30 provides power to lamp 6 and can include one or more heat dissipaters 32, such as transformers, that can generate and/or dissipate heat. In one embodiment, the heat dissipaters 32 of ballast 30 can also, or alternatively, include heat sinks that dissipate heat generated from a microprocessor or other structures within the interior of the lamp housing 2.

In the embodiment illustrated in FIG. 5, the utility door 10 includes at least one heat coupler 34 that thermally couples each heat dissipater 32 of ballast 30 to the lateral inside surface 28 of utility door 10. Heat coupler 34 is thermally coupled at a first end to one of the heat dissipaters 32 of ballast 30 and thermally coupled at a second end to the lateral inside surface 28. In an exemplary embodiment heat coupler 34 is mechanically attached to one of the heat dissipaters 32 and the lateral inside surface 28 via screws. In an alternative embodiment, the heat coupler 34 can be attached to a surface of the utility door 10 other than the lateral inside surface.

In one embodiment, heat coupler 34 can be a relatively thick copper strip. In alternative embodiments heat coupler 34 may be a relatively thick aluminum strip, a heat pipe, or any other suitable material that has a relatively high heat conductivity.

In certain embodiments, lateral inside surface 28 is generally opposed to outside surface having outwardly extending fins 20. In one embodiment, a portion of the utility door housing 11 that includes lateral inside surface 28 and fins 20 is formed substantially from cast aluminum. In other embodiments this portion of housing 11 may be formed from other relatively thermally conductive materials such as copper or any other suitable material. In one embodiment, the entire utility door housing 11 is formed substantially from aluminum. This provides an effective conductive heat path between inside lateral surface 28 of housing 11 and cooling fins 20. Thus, heat generated in ballast 30 can be efficiently transferred (1) conductively from heat dissipater 32 to inside lateral surface 28, (2) conductively through a wall of door housing 11 between inside lateral surface 28 and cooling fins 20, and/or (3) convectively from cooling fins 20 to an atmosphere surrounding utility door housing 11.

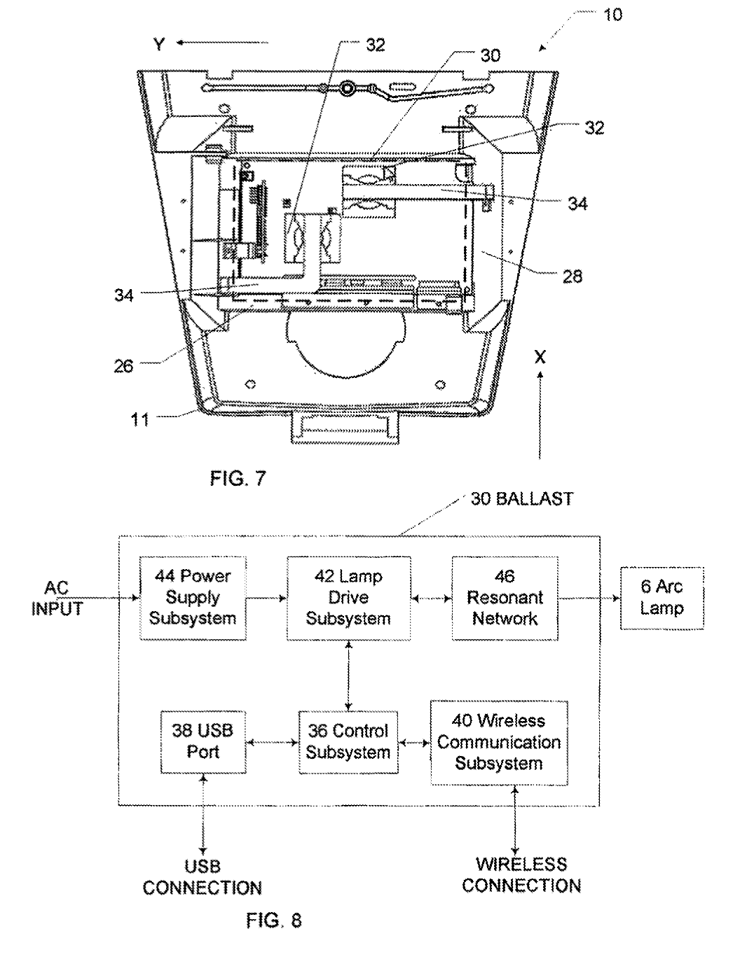

FIG. 7 is a top view of utility door 10 with protective covers 22 (illustrated in FIG. 6) removed. In this embodiment, heat couplers 34 extend laterally (in the X and Y directions) between heat dissipater 32 of ballast 30 and lateral inside walls 28 of utility door housing 11. In an alternative embodiment, heat couplers 34 may extend downwardly to mounting surface 26 to which ballast 30 is mounted or to any other portion of inside surface 24.

It is recognized that other embodiments are contemplated without deviating from the general scope of the present invention. For example, in one alternative embodiment, heat coupler 34 may include a combination of a heat exchanger and a fan that transfer heat from a dissipater 32 to an atmosphere outside of utility door housing 11. In this embodiment, each heat dissipater 32 can include a heat transfer device (not shown) such as an array of metal fins. Openings communicate between an inside surface 24 and an outside surface 18 of housing 11 to allow air to pass through housing 11. Thus, in this embodiment, heat coupler 34 is a forced air convection system for convectively transferring heat from heat dissipaters 32 to the outside atmosphere.

FIG. 8 is a block diagram of a ballast 30 coupled to high intensity discharge lamp 6 (indicated as “arc lamp”). Ballast 30 includes a control subsystem 36 that can include a microprocessor and memory (not shown). Control subsystem 36 is coupled to input/output devices such as USB port 38 or wireless communication subsystem 40 that enable an external device such as a laptop to upload control parameters to control subsystem 36.

Control subsystem 36 can also be coupled to lamp drive subsystem 42 so that the lamp 6 can be controlled and monitored. In this embodiment, lamp drive subsystem 42 receives power from power supply subsystem 44 and delivers power to resonant network 46 under control of control subsystem 36. Components of ballast 30 can dissipate considerable power that is efficiently transferred to cooling fins 20. The heat dissipaters 32 (illustrated in FIG. 5, for example) of ballast 30 may include transformers and heat sinks for removing heat from heat-generating components of ballast 30.

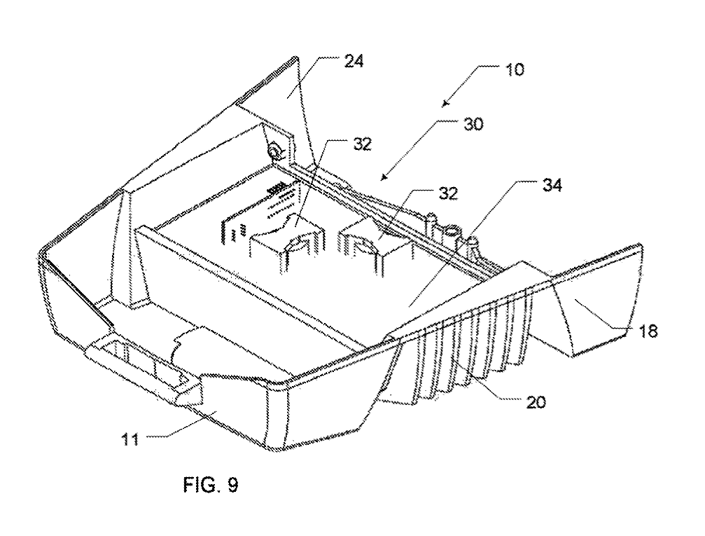

FIG. 9 is a top perspective view of an alternative embodiment of utility door 10. In this embodiment, utility door 10 includes a ballast 30 having heat dissipaters 32. Further, heat coupler 34 can be formed from a thermally conductive potting compound that thermally and mechanically couples ballast 30 to an inside surface 24 of utility door housing 11. One potential advantage of this embodiment is that in addition to providing a thermal pathway, heat coupler 34 improves the structural support and/or corrosion protection of electrical components for ballast 30. In this embodiment, heat can be transferred from heat dissipaters 32 in one or more of the following manners: (1) conductively through heat coupler 34 to inside surface 24, (2) conductively from inside surface 24 to outside surface 18 (through a wall of utility door housing 11), and/or (3) convectively from outside surface 18 of utility door housing 11.

In one embodiment, heat coupler 34 may be formed from a single or two-component epoxy or adhesive containing thermally conductive particles and/or fibers. In accordance with one embodiment, the potting compound may be poured over ballast 30 and inside surface 24 of utility door 10 and allowed to cure in place. Thermally conductive potting compounds are available from companies such as Loctite™ and Dow Corning™.

While a number of exemplary aspects and embodiments of a lamp housing 2 and utility door 10 have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A utility door for a lamp housing, the utility door comprising:
a utility door housing that closes a portion of an outside surface of the lamp housing, the utility door housing including an inside surface;
an electronic ballast mounted to the inside surface, the electronic ballast delivering power to the lamp, the electronic ballast including a heat dissipater; and
a heat coupler that thermally couples the heat dissipater to an outside atmosphere surrounding the utility door housing.

2. The utility door of claim 1 wherein the utility door housing includes a mounting surface, the electronic ballast being attached to the mounting surface.

3. The utility door of claim 1 wherein the heat dissipater includes one of a transformer and a heat sink for a processor.

4. The utility door of claim 1 wherein the heat coupler includes one of a heat pipe, a metal conductor, a potting compound, and a forced air system.

5. The utility door of claim 1 wherein the heat coupler includes a metal strip.

6. The utility door of claim 1 wherein the heat coupler includes a first end and a second end, the first end being thermally coupled to the heat dissipater, and the second end being coupled to an inside surface of the utility door housing.

7. The utility door of claim 1 wherein the heat coupler includes two or more thermal conductors, each thermal conductor being coupled to a separate heat dissipater of the electronic ballast.

8. The utility door of claim 1 wherein the inside surface of the utility door includes a lower portion and a lateral portion, the lower portion including a mounting portion for mounting the electronic ballast, and wherein the heat coupler is thermally coupled to the lateral portion.

9. A utility door for use with a lamp housing, the utility door comprising:
a utility door housing including an inside surface with an opposing outside surface that forms a portion of an outside surface of the lamp housing when the door housing is installed;
an electronic ballast mounted to a mounting portion of the inside surface of the utility door housing, the electronic ballast including a plurality of heat dissipaters; and
a heat coupler configured to transfer heat along a heat path such that heat is transferred (1) conductively along the heat coupler from the heat dissipater to the inside surface of the door housing, (2) conductively from the inside surface to the outside surface of the door housing, and (3) convectively from the outside surface of the door housing to an outside atmosphere.

10. The utility door of claim 9 wherein the heat coupler includes a metal strip.

11. The utility door of claim 9 wherein the heat coupler includes a potting compound.

12. The utility door of claim 9 wherein the heat coupler includes a first end and a second end, the first end being thermally coupled to one of the heat dissipaters, the second end being thermally coupled to a lateral portion of the inside surface of the utility door housing.

13. The utility door of claim 9 wherein the heat coupler includes two or more thermal conductors, each thermal conductor being coupled to a separate heat dissipater of the electronic ballast.

14. The utility door of claim 9 wherein the outside surface of the utility door housing includes a plurality of cooling fins.

15. A utility door for use with a lamp housing, the utility door comprising:
a utility door housing including an inside surface with an opposing outside surface having a plurality of outwardly extending cooling fins;
an electronic ballast mounted to the inside surface, the electronic ballast including a plurality of heat dissipaters and;
a heat coupler configured to transfer heat along a heat conductive path between at least one of the heat dissipaters and the outwardly extending cooling fins.

16. The utility door of claim 15 wherein the utility door housing is integrally formed substantially from aluminum.

17. The utility door of claim 15 wherein the heat coupler includes one of a heat pipe, a potting compound, and a metal conductor.

18. The utility door of claim 15 wherein the heat coupler includes a copper strip.

19. The utility door of claim 15 wherein the heat coupler includes a first end and a second end, the first end being thermally coupled to one of the heat dissipaters, the second end being thermally coupled to a lateral portion of the inside surface of the utility door housing.

20. The utility door of claim 15 wherein the heat coupler includes two or more thermal conductors, each thermal conductor being coupled to a separate heat dissipater of the electronic ballast.
